(19) United States
(12) Patent Application Publication
(10) Pub. No.: US 2026/0194252 A1
(43) Pub. Date: Jul. 9, 2026

(54) UTILIZING OCCUPANCY PREDICTION IN BUILDING MANAGEMENT SYSTEMS

(71) Applicant: Honeywell International Inc., Charlotte, NC (US)

(72) Inventors: Chris Inkpen, Horsham (GB); Michael A. Pouchak, St. Anthony, MN (US); Tony Lu, Atlanta, GA (US)

(21) Appl. No.: 19/436,772

(22) Filed: Dec. 30, 2025

Related U.S. Application Data
(60) Provisional application No. 63/741,656, filed on Jan. 3, 2025.

(51) Int. Cl. F24F 11/63; F24F 120/10; G05B 15/02

(52) U.S. Cl. CPC F24F 11/63; G05B 15/02; F24F 2120/10

(57) ABSTRACT

Systems, methods, controllers and machine readable instruction sets for a Building Management System of a building. Information technology and operational technology inputs are obtained and used to generate outputs to control aspects of the building, such as heating, ventilation and air conditioning. Occupancy estimates can be generated using a plurality of sources, such as WiFi access contacts, changes in CO2 in the space, and/or card swipes.

### CROSS REFERENCE TO RELATED APPLICATIONS

The present application claims the benefit of and priority to U.S. Provisional Pat. App. No. 63/741,656, filed Jan. 3, 2025, titled UTILIZING OCCUPANCY PREDICTION IN BUILDING MANAGEMENT SYSTEMS, the disclosure of which is incorporated herein by reference.

### BACKGROUND

Occupancy of a room or building space can significantly affect the power consumed by heating, ventilation, and air conditioning (HVAC) systems, lighting systems, general power systems, and other building systems. A building management system (BMS) which can predict and/or estimate occupancy is desirable to aid in the efficient provision of various services to the space. For example, a typical human at rest may generate about 100 Watts of power just through metabolic processes. A system which can proactively adjust HVAC settings and/or operation based on an occupancy prediction may be able to enhance energy efficiency and comfort.

### OVERVIEW

The present inventors have recognized, among other things, that a problem to be solved is the need for new and/or alternative systems and methods to provide occupancy estimations and predictive management of energy usage and/or comfort to a space.

An illustrative and non-limiting example takes the form of a method for controlling one or more components of a Building Management System (BMS) of a building in accordance with an estimated occupancy count of a space of the building, the method comprising: monitoring a number of wireless devices that are authenticated and connected to a wireless network in the space of the building; monitoring a number of wireless devices that are probing for the wireless network in the space of the building but are not authenticated and connected to the wireless network; determining the estimated occupancy count of the space of the building based at least in part on the number of wireless devices that are authenticated and connected to a wireless network in the space of the building and the number of wireless devices that are probing for the wireless network in the space of the building but are not authenticated and connected to the wireless network; and controlling the BMS based at least in part on the estimated occupancy count.

Additionally or alternatively, monitoring the number of wireless devices that are authenticated and connected to a wireless network in the space of the building comprises monitoring a WiFi Count for the space of the building.

Additionally or alternatively, monitoring the number of wireless devices that are probing for the wireless network in the space of the building but are not authenticated and connected to the wireless network comprises monitoring a Probing count for the space of the building.

Additionally or alternatively, determining the estimated occupancy count of the space of the building based at least in part on the WiFi Count and the Probing count comprises: summing the WiFi Count and the Probing count, resulting a cumulative count; determining a minimum of the cumulative count during a current day as a baseline; subtracting the baseline from the cumulative count, resulting in an adjusted cumulative count; and multiplying the adjusted cumulative count by a constant to get the estimated occupancy count of the space of the building.

Additionally or alternatively, further comprising monitoring at least part of the space of the building using one or more additional sensors; and determining the estimated occupancy count of the space of the building based at least in part on the number of wireless devices that are authenticated and connected to a wireless network in the space of the building, the number of wireless devices that are probing for the wireless network in the space of the building but are not authenticated and connected to the wireless network, and an output of one or more of the additional sensors.

Additionally or alternatively, the one or more additional sensors comprises one or more surveillance video cameras each producing a video stream, the method comprising: performing video analytics on the video stream from each of the one or more surveillance video cameras to identify an estimated video based occupancy count of space of the building; and determining the estimated occupancy count of the space of the building based at least in part on the estimated occupancy count of the space of the building based at least in part on the number of wireless devices that are authenticated and connected to a wireless network in the space of the building, the number of wireless devices that are probing for the wireless network in the space of the building but are not authenticated and connected to the wireless network, and the estimated video based occupancy count of space of the building.

Additionally or alternatively, the one or more additional sensors comprises one or more of a motion sensor, a card swipe count reported by an access control system of the building, a CO2 sensor, a power draw sensor, a humidity sensor, and a temperature sensor.

Additionally or alternatively, the one or more additional sensors comprises one or more CO2 sensors, the method comprising: monitoring a CO2 level in at least part of the space of the building using the one or more CO2 sensors; and determining the estimated occupancy count of the space of the building based at least in part on the number of wireless devices that are authenticated and connected to a wireless network in the space of the building, the number of wireless devices that are probing for the wireless network in the space of the building but are not authenticated and connected to the wireless network, and the CO2 level in at least part of the space of the building.

Additionally or alternatively, the method includes determining a heat and/or cooling load that is presented to the BMS of the building based at least in part on the estimated occupancy count of the space of the building.

Additionally or alternatively, the heat and/or cooling load that is presented to the BMS of the building is calculated by multiplying the estimated occupancy count of the space of the building by a fixed amount.

Additionally or alternatively, the monitoring, determining and controlling steps are performed by an edge controller, wherein the edge controller includes one or more processing resources that executes one or more containers.

Additionally or alternatively, one or more of the containers execute an Artificial Intelligence/Machine Learning algorithm that receives the number of wireless devices that are authenticated and connected to a wireless network in the space of the building and the number of wireless devices that are probing for the wireless network in the space of the building but are not authenticated and connected to the wireless network.

Additionally or alternatively, one or more of the containers output the estimated occupancy count of the space of the building.

Additionally or alternatively, one or more of the containers execute an Artificial Intelligence/Machine Learning algorithm that receives the WiFi Count and the Probing count and outputs one or more control outputs for controlling the BMS.

Additionally or alternatively, one or more of the containers execute an Artificial Intelligence/Machine Learning algorithm that receives the number of wireless devices that are authenticated and connected to a wireless network in the space of the building, the number of wireless devices that are probing for the wireless network in the space of the building but are not authenticated and connected to the wireless network and one or more additional sensors, and outputs one or more of the estimated occupancy count of the space of the building and/or one or more control outputs for controlling the BMS.

Another illustrative and non-limiting example takes the form of an edge controller for a Building Management System (BMS) of a building, the edge controller comprising: one or more IT inputs for receiving IT inputs from an IT system; one or more OT inputs for receiving OT inputs from an OT system; one or more outputs for outputting one or more control outputs for controlling the BMS of the building; one or more processing resources operatively coupled to the one or more IT inputs, the one or more OT inputs and the one or more outputs, the one or more processing resources executing one or more containers, wherein the one or more containers are configured to: monitor via one or more of the IT inputs for a number of wireless devices that are authenticated and connected to a wireless network of the building; monitor via one or more of the IT inputs for a number of wireless devices that are probing for the wireless network of the building but are not authenticated and connected to the wireless network; determine an estimated occupancy count of the building based at least in part on the number of wireless devices that are authenticated and connected to a wireless network of the building and the number of wireless devices that are probing for the wireless network of the building but are not authenticated and connected to the wireless network; and provide one or more control outputs via one or more of the outputs based at least in part on the estimated occupancy count.

Additionally or alternatively, the one or more containers are configured to: determine the estimated occupancy count of the building by: summing the number of wireless devices that are authenticated and connected to a wireless network of the building and the number of wireless devices that are probing for the wireless network of the building but are not authenticated and connected to the wireless network, resulting a cumulative count; determining a minimum of the cumulative count during a current day as a baseline; subtracting the baseline from the cumulative count, resulting in an adjusted cumulative count; and multiplying the adjusted cumulative count by a constant to determine the estimated occupancy count of the building.

Additionally or alternatively, the one or more containers are configured to: monitor via one or more of the OT inputs one or more sensed conditions in the building; and determine the estimated occupancy count of the building based at least in part on the number of wireless devices that are authenticated and connected to a wireless network of the building, the number of wireless devices that are probing for the wireless network of the building but are not authenticated and connected to the wireless network, and the one or more sensed conditions in the building.

Additionally or alternatively, the one or more sensed conditions comprises one or more of motion, a number of card swipes reported by an access control system of the building, CO2 level, power draw level, humidity, and temperature.

Another illustrative example takes the form of a non-transitory computer readable medium storing instructions thereon that when executed by one or more processors cause the one or more processors to: monitor one or more IT inputs; monitor one or more OT inputs; determine an estimated occupancy count of at least part of a building based at least in part on one or more of the IT inputs and one or more of the OT inputs; output a control output to control at least part of a Building Management System (BMS) of a building based at least in part on the estimated occupancy count; wherein the one or more IT inputs in which the estimated occupancy count is at least partially based includes one or more of: a number of wireless devices that are authenticated and connected to a wireless network of the building; a number of wireless devices that are probing for the wireless network of the building but are not authenticated and connected to the wireless network; a camera count of people in the building reported by a video analytics module of a video surveillance camera of the building; and a number of card swipes reported by an access control system of the building; wherein the one or more OT inputs in which the estimated occupancy count is at least partially based includes one or more of motion, CO2 level, power draw level, humidity, and temperature.

This overview is intended to introduce the subject matter of the present patent application. It is not intended to provide an exclusive or exhaustive explanation. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an overall architecture for predicting an occupancy in a space;

FIG. 2 shows an illustrative edge architecture;

FIG. 3 shows an illustrative artificial intelligence architecture;

FIG. 4 shows an illustrative control for a variable air volume (VAV) device using an occupancy estimate;

FIG. 5 shows an illustrative control system with a VAV and controlled space;

FIG. 6 shows an illustrative building management system with occupancy estimation module;

FIG. 7 shows an illustrative method in block form;

FIG. 8 shows an illustrative edge controller; and

FIGS. 9A-9B show an illustrative instructions architecture.

### DETAILED DESCRIPTION

In examples, the present matter relates to a system and method for integrating occupancy prediction from various third-party sources, such as Cisco Spaces or Hewlett Packard Enterprise (HPE), into an embedded BMS (Building Management System) control environment. In some cases, the system is designed to collect data from these sources and consolidate them into an AI (Artificial Intelligence) SNAPS (SDN/NFV Application Development Platform and Stack) container using a MQTT (Message Queuing Telemetry Transport) communication protocol. The core algorithm within the SNAPS container may be based on a Random Forest algorithm, which analyzes multiple occupancy cues/data to optimize the control of heating and cooling loads within a building environment. This innovative control suite may function as a Zone controller, automatically integrating occupancy signals from diverse sources like PIR sensors, cameras, card swipes, and third-party systems such as Cisco and HPE IT (Information Technology) systems. By leveraging AI models trained to understand the correlation between room temperature and occupancy levels, the system can dynamically adjust heating and cooling demands in a more intelligent and energy-efficient manner. Considering that a typical human at rest generates approximately 100 Watts of power through metabolic processes, the system can proactively adjust heating and cooling settings based on occupancy predictions for optimized energy and comfort management.

The system described herein integrates occupancy prediction capabilities from external sources into an embedded BMS control environment. By extracting data from various third-party sources, such as Cisco Spaces and HPE IT systems, the system brings this data into a unified AI SNAPS container through MQTT communication. Utilizing a Random Forest algorithm within the SNAPS container, the system processes multiple occupancy cues to make informed decisions on regulating heating and cooling outputs that drive building comfort levels. This control suite, operating as a Zone controller, seamlessly integrates occupancy signals from diverse sensors and systems, including PIR sensors, cameras, card swipes, and external systems like Cisco and HPE.

Illustrative examples herein may focus on smaller subsets of the data input and output of an overall system. For example, an overall system may generate occupancy predictions using multiple sources of data, and some examples may focus on clusters or groups of (often related) data sources. Some examples may use a wireless network as a monitoring source during operation to generate an estimated occupancy count. Other data sources may be used during, for example, training of the AI. Thus for example, a wireless network analysis can be used to generate estimated data in a training sequence, and other sources can generate other estimates. These “other estimates” may include hand-counting occupants, estimates based on an understanding of CO2 balance, estimates based on motion sensors, estimates based on video analytics (video-based AI person counts for example), etc.

In some cases, the system optimizes heating and cooling control by training AI models to decipher the intricate relationship between room temperature and occupancy levels. In some cases, the AI models may predict future occupancy patterns. By predicting future occupancy patterns, and proactively adjusting control settings accordingly, the system can enhance energy efficiency and occupant comfort. Moreover, leveraging the estimated power generation of a human at rest (e.g. 100 Watts per human), the system may proactively modify heating and cooling operations to align with predicted occupancy, leading to more effective energy management strategies. This integration of occupancy prediction in an embedded BMS control setting marks a significant advancement in building automation technologies, paving the way for smarter and more sustainable building operations.

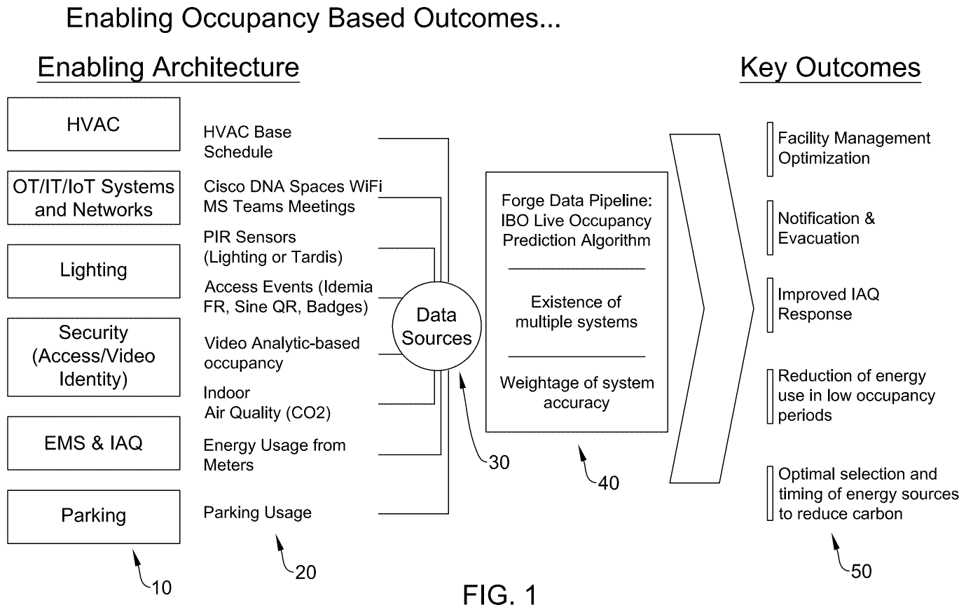

FIG. 1 shows an overall architecture for predicting an occupancy in a space. A number of systems may be present in a facility as indicated at 10, including heating, ventilation, and air conditioning (HVAC). HVAC system operations can be used to determine base schedule and modifications or changes made by users, which are indicative of occupancy and which can be used in combination with other data to estimate occupancy. Operational technology (OT), informational technology (IT) and Internet of Things systems and networks can be used, including the previously noted Cisco DNA Spaces WiFi system, indications of polling of the local wifi and other interactions with wireless devices, interactions with Bluetooth and other wireless system in the building and space, etc. IT systems may obtain data, for example, from software applications used for collaboration, meetings, etc., including Microsoft Teams as a particular example, as well as other systems (Zoom, etc.) which can indicate the presence of people on-site. Lighting systems, some of which are automated, may include passive infrared (PIR) sensors or other motion and presence sensors, as well as switches and the like; interactions with these systems and devices also give indications of occupancy.

Security systems, which may include access controls (badge readers, door sensors, etc.) as well as video monitoring systems can also be used to detect and quantify occupancy. Energy monitoring systems (EMS), such as smart plugs, and indoor air quality (IAQ) monitors can provide additional occupancy data, as the smart plugs of an EMS can detect access to power by individuals, and IAQ monitors are able to detect occupancy using generated CO2. Parking usage can also be monitored, as indicated.

The devices and systems in the building or space noted at 10 generate a plurality of data as noted at 20, which are treated as data sources 30 for the system. The illustrative system uses these data sources 30 in a live occupancy prediction algorithm, as indicated at 40, which relies on the existence of multiple systems, which can be weighted for accuracy, to yield an occupancy estimate, as further detailed below.

The occupancy estimate relying on a plurality of sources with internal weighting can provide greater accuracy. As a result, several positive outcomes 50 can be realized. Outcomes 50 may include facility management optimization, data inputs useful for alerts, notifications and, in emergencies, evacuation, improved indoor air quality as well as response to changes in indoor air quality due to increased (or decreased) occupancy. When low occupancy is detected, energy use can be reduced to save resources. When occupancy can be quantified and predicted, the selection or use of available energy sources may be optimized as well, reducing, for example, carbon utilization.

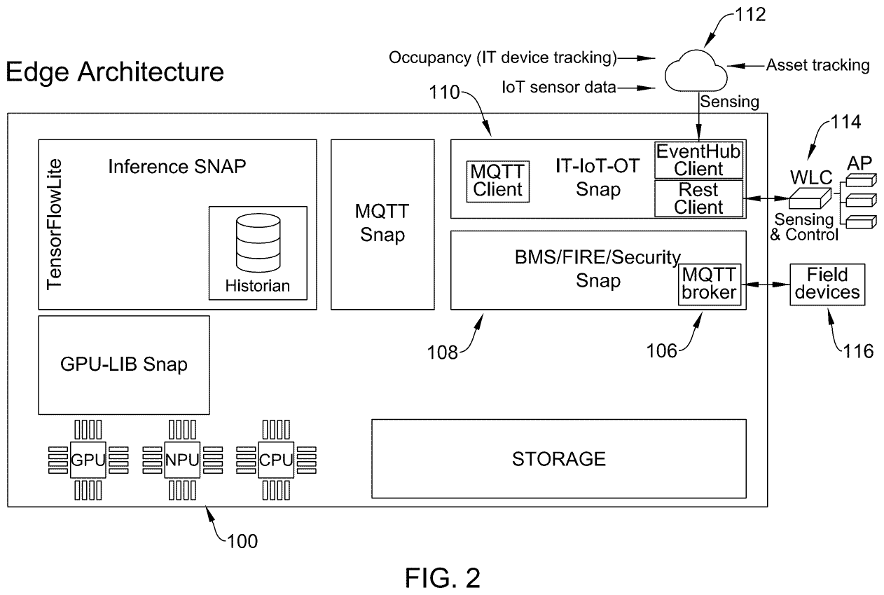

FIG. 2 shows an illustrative edge architecture. In some cases, the edge controller utilizes an NXP SMARC i.MX 8M Plus Computer on Module available from Toradex Group, which is a high-performance embedded Linux device. As depicted in FIG. 2, this device 100 operates on Canonical SNAPS and custom Control SNAPS. SNAPS are self-contained packages that work across a range of Linux distributions. In the example shown, the communication interface between these components is facilitated by an MQTT broker, which acts as a conduit for transmitting real-time Building Management System (BMS) data such as Room and Outside Temperatures and managing zone setpoints to the AI inference SNAPS. As shown, the MQTT broker 106 is defined with the BMS, Fire and Security SNAP 108, and received data from the range of field devices 116 that provide sensing and operations in the BMS, Fire and Security systems, which may include access controls, temperature, humidity and other sensors (including CO2), cameras, etc.

Subsequently, additional occupancy information may be integrated by merging data from REST and Event HUB (Kafka) APIs, enabling the retrieval of real-time telemetry data from an Information Technology (IT) domain. The integration of IT and Operational Technology (OT) data enhances the system's capability to adapt to a broader array of occupancy indicators beyond traditional OT data sources.

Thus in FIG. 2, the MQTT client is part of an IT/IoT/OT SNAP 110, which obtains various sensing data from IT device tracking, IoT, and asset tracking, which may be generated and transmitted via the cloud 112 or by other communications (local WiFi, Ethernet, optic fiber, etc.) as desired, which feed to the Event HUB block in the IT/IoT/OT SNAP 110. The wireless local area network controller (WLC), and the various access point (AP) devices used, are coupled to the Representational State Transfer (REST) to allow communication between the different systems, again as a client shown in the IT/IoT/OT SNAP 110. The computing device 100 may include each of a GPU, NPU and CPU, as indicated in the lower left side.

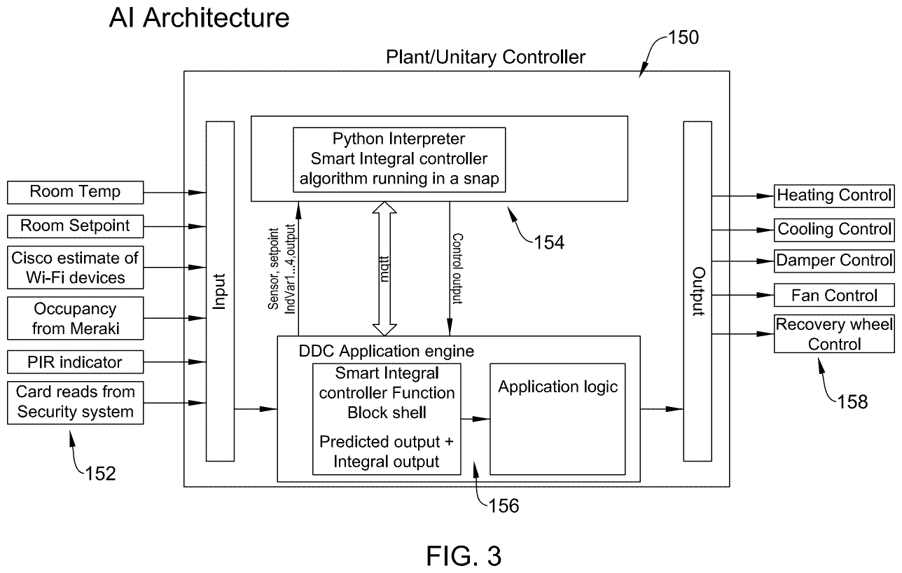

FIG. 3 shows an illustrative artificial intelligence architecture 150. Inputs are read from the left-hand side of the diagram. These represent a combination of real control points from a BMS system, and additional inputs from third party systems such as Cisco/HPE IT systems. Inputs 150 include, for example, room temperature, room setpoint (BMS/HVAC-derived data), estimated counts of WiFi devices (or Bluetooth or other wireless communications devices), occupancy data from Meraki systems (or other camera-based systems which can provide occupancy counts/estimates), passive infrared (PIR) indicators or sensors data, as well as card reads from the security system. Not all inputs may be used; additional inputs or different sets of inputs can be taken. What is observed is that inputs are derived from the BMS systems that control and monitor the physical space, as well as IT/IoT/OT systems that interact with devices carried or used by the occupants in the space.

The inputs 152 are fed into a Smart Integral controller 154 which is used to train how the controller 156 should behave. The output of the control module 156 is a position or setpoint for various components 158 of the BMS system. Illustrative components or control signals may include heating control, cooling control, damper control, fan control, and/or recovery wheel control, for example and without limitation.

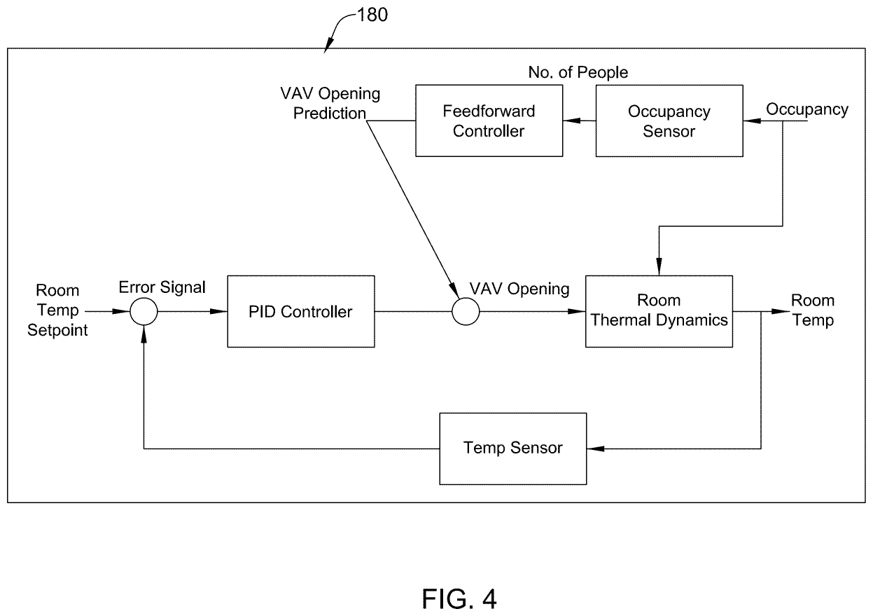

FIG. 4 shows a specific example. In FIG. 4, an illustrative control for a variable air volume (VAV) device using an occupancy estimate is implemented. The process is shown generally at 180. The system receives a room temperature setpoint, which is compared to the output of a temperature sensor to yield an error signal (mismatch between actual temperature and setpoint). A proportional-integral-derivative (PID) controller can be used to control the VAV opening. The VAV opening in turn adds or subtracts heat energy from the room, and a room temperature results in the real world (which is then sensed in the feedback loop). The occupancy estimate is obtained at an occupancy sensor, based on the real world occupancy, which, as shown, also affects the room thermal dynamics. A feedforward control is used to generate a prediction for the VAV opening. The system of FIG. 4 can be used to observe the error signals over time, as a way of setting baseline energy consumption and conformity to desired setpoints as occupancy varies, as well as to train the underlying model, since the error signals over time and predicted and observed changes in the VAV opening can be compared. That is, the occupancy variable is repeatedly estimated over time, and is used as an input to a modeled set of room thermal dynamics in the training, which would yield an expected VAV position. If the actual occupancy is characterized correctly, the VAV opening prediction will match the actual VAV opening (absent HVAC fault); if not, the occupancy characterization is updated in the machine learning algorithm.

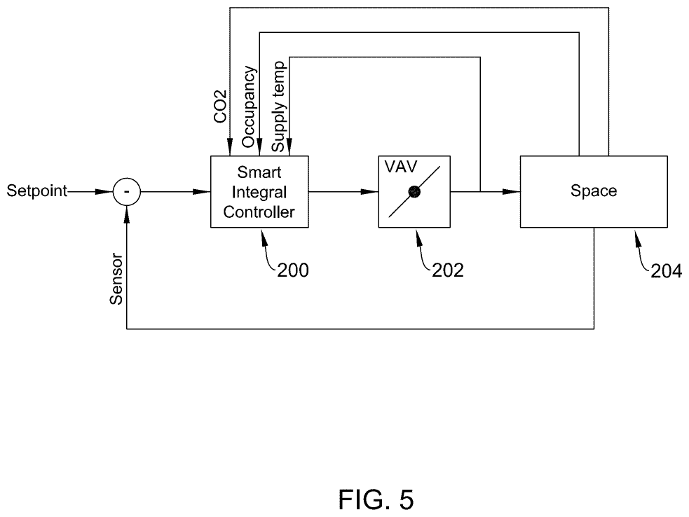

FIG. 5 shows an illustrative control system with a VAV and controlled space. Here, the model is now online and operating. Rather than using the PID controller of FIG. 4, the smart integral controller, having been trained as explained relative to FIG. 4, is now implemented. The controller is shown at 200, and receives a setpoint, which is compared to a sensor data; the sensor and setpoint may be for humidity and/or temperature, for example.

The controller 200 also receives various inputs including a CO2 sensor input, a supply temperature, and an occupancy estimate. The occupancy estimate is managed using the previously described trained models. The controller 200 provides a control signal to the VAV 202, which in turn delivers controlled air to the space 204.

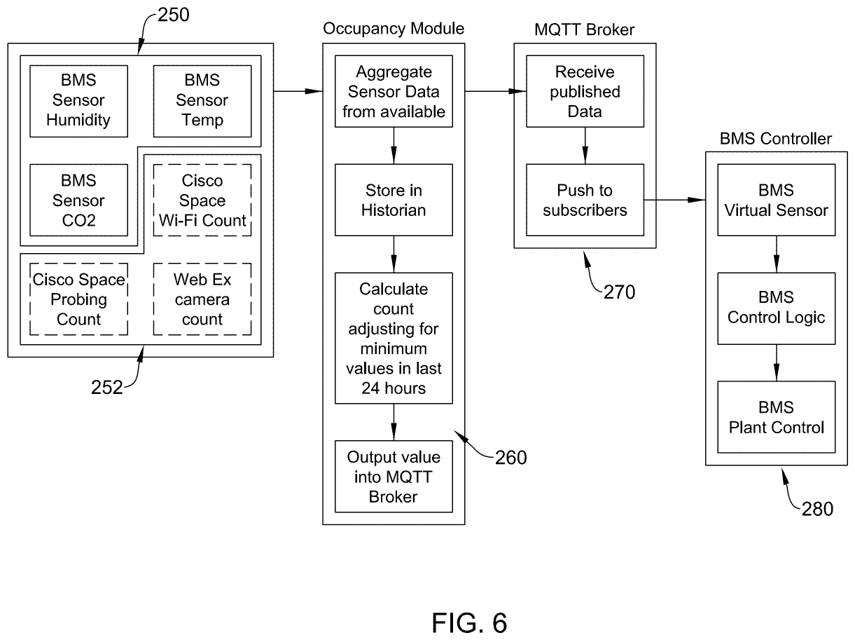

FIG. 6 shows an illustrative building management system with occupancy estimation module. Here, the occupancy module 260 receives BMS inputs, which may include sensed humidity, sensed temperature, and/or sensed CO2 (or other sensor inputs, as desired). The occupancy module 260 also receives IT/IoT/OT data 252, such as from the space Wi-Fi counter, space probing count, and/or camera counts (here, using a linked WebEx system to determine how many devices operating using WebEx are present in the space). Other BMS inputs can include those from fire and/or security, including access control counts, PIR sensors, etc., and other sources noted herein. Other IT/IoT/OT data may include other sources identified herein.

The occupancy module 260 uses a process flow as indicated to provide data to the MQTT broker 270. This may include aggregating the available sensor data, which is stored in a historian. A count is then calculated, and may be adjusted for minimum values from the preceding 24 hours, as noted. For example, if a thermal model is used, the space has its own thermal dynamics, including windows, doors, openings, etc., and will absorb and lose heat regardless of occupancy. An output estimate is generated and then provided to the MQTT Broker 270.

The MQTT Broker 270 receives the data published by the occupancy module, and pushes the data to subscribers, which include a BMS controller 280. The BMS controller may use a virtual sensor, merging data from multiple BMS sensors as well as the occupancy data received from the MQTT Broker. The BMS control logic may also use the MQTT Broker data, if desired. For example, with PID control, how quickly or slowly the HVAC system responds to deviations from the setpoint may be adjusted up or down in response to greater or lesser occupancy. As a specific example, with greater occupancy, tools in the HVAC system that can be used to reduce humidity may be activated more quickly than when there is lesser occupancy, to avoid allowing humidity to rise to an uncomfortable or unhealthy level in the space. In another example, the heat and/or cooling load that is presented to the BMS of the building is calculated by multiplying the estimated occupancy count of the space of the building by a fixed amount and adding or subtracting, as suitable to whether a heating or cooling operation is needed, from the requested load. The BMS control logic in turn provides control signals for BMS plant control.

In some examples, for a given floor or area, the system may sum a wireless probing count and a Wi-Fi count associated with a wireless network, and then subtract the minimum of the sum for that day and multiply the result by a constant (based upon floor type) to get an estimated occupancy count value for the floor. In this example, Wi-Fi count may be the number of authenticated and connected wireless devices to a WiFi Network in a space of the building, which may provide a good correlation to the number of authenticated mobile devices in the space. The Probing Count may be the number of Wi-Fi devices in the space that have their Wi-Fi adaptor turned on and are probing to see if there are any trusted SSID's they can connect to (but are not yet authenticated and connected to the wireless network). The probing devices typically use randomized MAC address, and the WiFi system (such as certain products available from Cisco) will estimate many unique probing devices are in the space.

Some examples may use a PIR (Passive Infrared) Sensor Event as an indication of 1 or more people in an area. By aggregating such counts, particularly if sensors are available in areas of ingress or egress, foot traffic into and out of the space can be estimated, for example.

Some examples may analyze the rate of change of CO2 in the space, and compare with the amount of fresh air coming into the building. Such examples may be initialized using BMS data including, for example, the volume of air in the room or space. Since the volume of the room is known, the system may then estimate the number of people in the room based on assumptions of Rate of Change of fresh air passing via the air handling unit (AHU) and/or other sources, and rate of breathing CO2 per person. The following equation may be used to calculate the number of people based upon assumptions of Rate of Change of fresh air in a room and a rate of breathing CO2 per person:

$$c = ( q / nV ) ( 1 - 1 / e \hat{} n t ) + ( c 0 - c 1 ) / ( 1 / e \hat{} n t ) + c 1 ;$$

where:
V=Volume of the floor or area in m3;
n=number of air exchanges in the area passing through the AHU per hour;
c=CO2 concentration in the room (m3/m3);
q=CO2 supplied to the room in the time period t=(p*q0);
t=time period-often 15 minutes;
c1=CO2 concentration being supplied through AHU;
c0=CO2 concentration t time units ago;
q0=Average CO2 supplied by one person per hour (0.05) m3; and
p=number of people.
   By reading values every time period (e.g. 15 minutes), the number of people in the room in the last hour can be estimated, by using the assumption that p=q/q0.

WebEx (or other video system) may be used to obtain a camera occupancy count that is determined using video analytics algorithms running on video streams from the WebEx video cameras. The MQTT can be used to obtain such data from external IT/IoT/OT sources, for example.

BMS security data may be used by obtaining card swipes and other access control data.

The system may output an occupancy count and/or a heat load based upon identification of the occupancy count (e.g. 100W per person) and in some cases equipment (e.g. computers, monitors, etc.) running in the space. The system is intended to require minimal engineering and be self-adaptive but output meaningful data that can be utilized by downstream control algorithms (e.g. BMS control algorithms). A heat model can be a simple input-output model, taking into account, for example, external temperature, insulation, and air flow. By treating the space as a “box”, and assuming heat loss or heat gain from passive external sources, along with the active input or extraction of heat using BMS systems, a person count can be estimated using an assumed heat generated per person. Further, connected power devices, such as smart plugs/outlets, can determine and/or estimate how much power is used in the space, assuming that all such power is generally converted to heat. Lighting can generate heat as well, and the lights in the space can be modeled for how much heat each light source generates.

In some cases, an AI model may be initially trained using some factual evidence, such as using one or more of:
Use of a Camera to physically count people
Using a people counting algorithm with ST Electronics: VL53L1X (Time of Flight Sensor) (https://www.st.com/en/embedded-software/stsw-img010.html)
Using Physical feedback systems which allow people to enter the actual count on a Tablet placed in the area.
   These are just examples. The AI model may estimate how many Wi-Fi devices are held for each person (e.g. occupant), and use this information in conjunction with auto-adjusting a minimal value in the room in each 24-hour period when desired to identify an estimated occupancy count. The occupancy count may be dynamically adjusted against a baseline count. The baseline count may be a minimum of the estimated occupancy count occurring in the last 24 hours. That is, the minimum WC+PC throughout the day may be considered the baseline count.

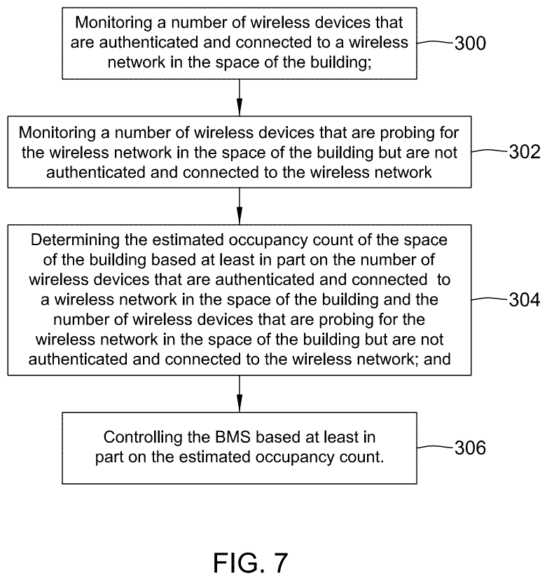

Turning now to FIG. 7, in some instances, a method for controlling one or more components of a Building Management System (BMS) of a building in accordance with an estimated occupancy count of a space of the building. The method includes monitoring a number of wireless devices that are authenticated and connected to a wireless network in the space of the building, as indicated at 300. The method next includes monitoring a number of wireless devices that are probing for the wireless network in the space of the building but are not authenticated and connected to the wireless network, as indicated at 302. The estimated occupancy count of the space of the building is determined based at least in part on the number of wireless devices that are authenticated and connected to a wireless network in the space of the building and the number of wireless devices that are probing for the wireless network in the space of the building but are not authenticated and connected to the wireless network, as indicated at 304. The BMS is controlled based at least in part on the estimated occupancy count, as indicated at 306. Other inputs as described above may also be used.

In some cases, monitoring the number of wireless devices that are authenticated and connected to a wireless network in the space of the building may include monitoring a WiFi Count for the space of the building. The WiFi count may be determined using Cisco Space tools, for example, or similar WiFi networking tools. In some cases, monitoring the number of wireless devices that are probing for the wireless network in the space of the building but are not authenticated and connected to the wireless network may include monitoring a Probing count for the space of the building. The Probing count may be determined using Cisco Space tools, for example, or similar WiFi networking tools. In some cases, determining the estimated occupancy count of the space of the building based at least in part on the WiFi Count and the Probing count may include summing the WiFi Count and the Probing count, resulting a cumulative count, determining a minimum of the cumulative count during a current day as a baseline, subtracting the baseline from the cumulative count, resulting in an adjusted cumulative count, and multiplying the adjusted cumulative count by a constant to get the estimated occupancy count of the space of the building.

In some cases, the method may include monitoring at least part of the space of the building using one or more additional sensors and determining the estimated occupancy count of the space of the building based at least in part on the number of wireless devices that are authenticated and connected to a wireless network in the space of the building, the number of wireless devices that are probing for the wireless network in the space of the building but are not authenticated and connected to the wireless network, and an output of one or more of the additional sensors. In some cases, the one or more additional sensors may include one or more surveillance video cameras each producing a video stream. In some cases, the method includes performing video analytics on the video stream from each of the one or more surveillance video cameras to identify an estimated video based occupancy count of space of the building and determining the estimated occupancy count of the space of the building based at least in part on the estimated occupancy count of the space of the building based at least in part on the number of wireless devices that are authenticated and connected to a wireless network in the space of the building, the number of wireless devices that are probing for the wireless network in the space of the building but are not authenticated and connected to the wireless network, and the estimated video based occupancy count of space of the building.

In some cases, the one or more additional sensors may include one or more of a motion sensor, a card swipe count reported by an access control system of the building, a CO2 sensor, a power draw sensor, a humidity sensor, and a temperature sensor. In some cases, the one or more additional sensors may include one or more CO2 sensors. The method may include monitoring a CO2 level in at least part of the space of the building using the one or more CO2 sensors and determining the estimated occupancy count of the space of the building based at least in part on the number of wireless devices that are authenticated and connected to a wireless network in the space of the building, the number of wireless devices that are probing for the wireless network in the space of the building but are not authenticated and connected to the wireless network, and the CO2 level in at least part of the space of the building.

In some cases, the method may include determining a heat and/or cooling load that is presented to the BMS of the building based at least in part on the estimated occupancy count of the space of the building. In some cases, the heat and/or cooling load that is presented to the BMS of the building may be calculated by multiplying the estimated occupancy count of the space of the building by a fixed amount.

In some cases, the monitoring, determining and controlling steps may be performed by an edge controller that includes one or more processing resources that executes one or more containers. In some cases, one or more of the containers may execute an Artificial Intelligence/Machine Learning algorithm that receives the number of wireless devices that are authenticated and connected to a wireless network in the space of the building and the number of wireless devices that are probing for the wireless network in the space of the building but are not authenticated and connected to the wireless network. In some cases, one or more of the containers may output the estimated occupancy count of the space of the building. In some cases, one or more of the containers may execute an Artificial Intelligence/Machine Learning algorithm that receives the WiFi Count and the Probing count and outputs one or more control outputs for controlling the BMS. In some cases, one or more of the containers may execute an Artificial Intelligence/Machine Learning algorithm that receives the number of wireless devices that are authenticated and connected to a wireless network in the space of the building, the number of wireless devices that are probing for the wireless network in the space of the building but are not authenticated and connected to the wireless network and one or more additional sensors, and outputs one or more of the estimated occupancy count of the space of the building and/or one or more control outputs for controlling the BMS.

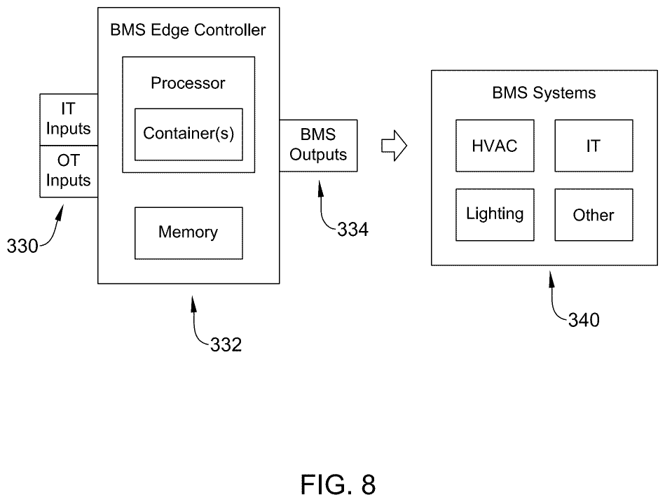

Turning to FIG. 8, in some instances, an edge controller for a Building Management System (BMS) of a building includes one or more IT inputs for receiving IT inputs from an IT system, and one or more OT inputs for receiving OT inputs from an OT system, as indicated at 330. The BMS edge controller 332 generates one or more outputs 334 for outputting one or more control outputs for controlling the BMS 340 of the building. As shown, the BMS edge controller 332 includes a processor coupled to a memory. The processor is operatively coupled to the one or more IT inputs, the one or more OT inputs 330 and the one or more outputs 334.

The one or more processing resources execute one or more containers. The one or more containers are configured to monitor via one or more of the IT inputs for a number of wireless devices that are authenticated and connected to a wireless network of the building. The one or more containers are configured to monitor via one or more of the IT inputs for a number of wireless devices that are probing for the wireless network of the building but are not authenticated and connected to the wireless network. The one or more containers are configured to determine an estimated occupancy count of the building based at least in part on the number of wireless devices that are authenticated and connected to a wireless network of the building and the number of wireless devices that are probing for the wireless network of the building but are not authenticated and connected to the wireless network. The one or more containers are configured to provide one or more control outputs via one or more of the outputs based at least in part on the estimated occupancy count.

In some cases, the one or more containers may be configured to determine the estimated occupancy count of the building by summing the number of wireless devices that are authenticated and connected to a wireless network of the building and the number of wireless devices that are probing for the wireless network of the building but are not authenticated and connected to the wireless network, resulting a cumulative count, determining a minimum of the cumulative count during a current day as a baseline, subtracting the baseline from the cumulative count, resulting in an adjusted cumulative count; and multiplying the adjusted cumulative count by a constant to determine the estimated occupancy count of the building. In some cases, the one or more containers may be configured to monitor via one or more of the OT inputs one or more sensed conditions in the building and determine the estimated occupancy count of the building based at least in part on the number of wireless devices that are authenticated and connected to a wireless network of the building, the number of wireless devices that are probing for the wireless network of the building but are not authenticated and connected to the wireless network, and the one or more sensed conditions in the building. In some cases, the one or more sensed conditions may include one or more of motion, a number of card swipes reported by an access control system of the building, CO2 level, power draw level, humidity, and temperature.

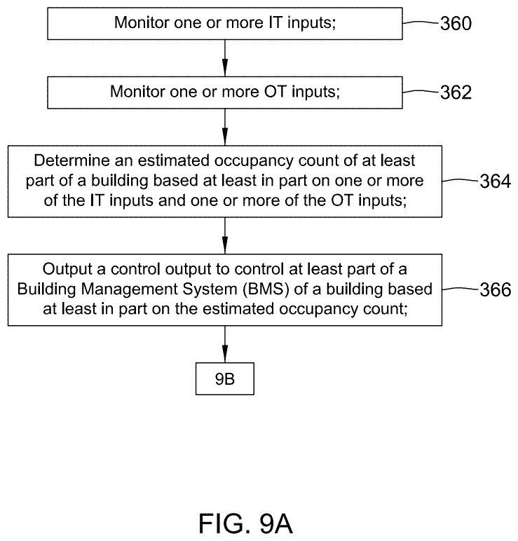

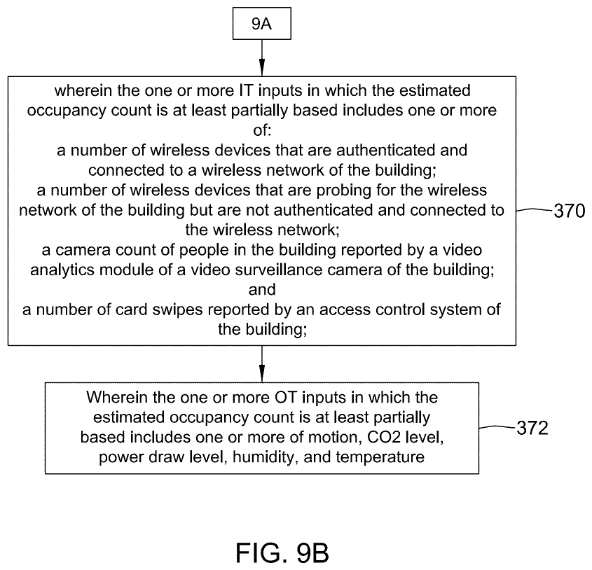

Turning to FIGS. 9A-9B, in some examples, a non-transitory computer readable medium stores instructions thereon. As shown in FIG. 9A, when the stored instructions are executed by one or more processors, the one or more processors are caused to monitor one or more IT inputs 360. The one or more processors are caused to monitor one or more OT inputs 362. The one or more processors are caused to determine an estimated occupancy count of at least part of a building based at least in part on one or more of the IT inputs and one or more of the OT inputs 364. The one or more processors are caused to output a control output to control at least part of a Building Management System (BMS) of a building based at least in part on the estimated occupancy count 366.

Turning to FIG. 9B, the one or more IT inputs in which the estimated occupancy count is at least partially based includes one or more of a number of wireless devices that are authenticated and connected to a wireless network of the building, a number of wireless devices that are probing for the wireless network of the building but are not authenticated and connected to the wireless network, a camera count of people in the building reported by a video analytics module of a video surveillance camera of the building, and a number of card swipes reported by an access control system of the building, as indicated at 370. The one or more OT inputs in which the estimated occupancy count is at least partially based may include one or more of motion, CO2 level, power draw level, humidity, and temperature, as indicated at 372.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” Moreover, in the claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic or optical disks, magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims.

Also, in the above Detailed Description, various features may be grouped together to streamline the disclosure. This should not be interpreted as intending that an unclaimed disclosed feature is essential to any claim. Rather, innovative subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the protection should be determined with reference to the appended claims, along with the full scope of equivalents to which such claims are entitled.

What is claimed is:

1. A method for controlling one or more components of a Building Management System (BMS) of a building in accordance with an estimated occupancy count of a space of the building, the method comprising:
monitoring a number of wireless devices that are authenticated and connected to a wireless network in the space of the building;
monitoring a number of wireless devices that are probing for the wireless network in the space of the building but are not authenticated and connected to the wireless network;
determining the estimated occupancy count of the space of the building based at least in part on the number of wireless devices that are authenticated and connected to a wireless network in the space of the building and the number of wireless devices that are probing for the wireless network in the space of the building but are not authenticated and connected to the wireless network; and
controlling the BMS based at least in part on the estimated occupancy count.

2. The method of claim 1, wherein monitoring the number of wireless devices that are authenticated and connected to a wireless network in the space of the building comprises monitoring a WiFi Count for the space of the building.

3. The method of claim 2, wherein monitoring the number of wireless devices that are probing for the wireless network in the space of the building but are not authenticated and connected to the wireless network comprises monitoring a Probing count for the space of the building.

4. The method of claim 3, wherein determining the estimated occupancy count of the space of the building based at least in part on the WiFi Count and the Probing count comprises:
summing the WiFi Count and the Probing count, resulting a cumulative count;
determining a minimum of the cumulative count during a current day as a baseline;
subtracting the baseline from the cumulative count, resulting in an adjusted cumulative count; and
multiplying the adjusted cumulative count by a constant to get the estimated occupancy count of the space of the building.

5. The method of claim 1, comprising:
monitoring at least part of the space of the building using one or more additional sensors; and
determining the estimated occupancy count of the space of the building based at least in part on the number of wireless devices that are authenticated and connected to a wireless network in the space of the building, the number of wireless devices that are probing for the wireless network in the space of the building but are not authenticated and connected to the wireless network, and an output of one or more of the additional sensors.

6. The method of claim 5, wherein the one or more additional sensors comprises one or more surveillance video cameras each producing a video stream, the method comprising:
performing video analytics on the video stream from each of the one or more surveillance video cameras to identify an estimated video based occupancy count of space of the building; and
determining the estimated occupancy count of the space of the building based at least in part on the estimated occupancy count of the space of the building based at least in part on the number of wireless devices that are authenticated and connected to a wireless network in the space of the building, the number of wireless devices that are probing for the wireless network in the space of the building but are not authenticated and connected to the wireless network, and the estimated video based occupancy count of space of the building.

7. The method of claim 5, wherein the one or more additional sensors comprises one or more of a motion sensor, a card swipe count reported by an access control system of the building, a CO2 sensor, a power draw sensor, a humidity sensor, and a temperature sensor.

8. The method of claim 7, wherein the one or more additional sensors comprises one or more CO2 sensors, the method comprising:
monitoring a CO2 level in at least part of the space of the building using the one or more CO2 sensors; and
determining the estimated occupancy count of the space of the building based at least in part on the number of wireless devices that are authenticated and connected to a wireless network in the space of the building, the number of wireless devices that are probing for the wireless network in the space of the building but are not authenticated and connected to the wireless network, and the CO2 level in at least part of the space of the building.

9. The method of claim 1, comprising determining a heat and/or cooling load that is presented to the BMS of the building based at least in part on the estimated occupancy count of the space of the building.

10. The method of claim 9, wherein the heat and/or cooling load that is presented to the BMS of the building is calculated by multiplying the estimated occupancy count of the space of the building by a fixed amount.

11. The method of claim 3, wherein the monitoring, determining and controlling steps are performed by an edge controller, wherein the edge controller includes one or more processing resources that executes one or more containers.

12. The method of claim 11, wherein one or more of the containers execute an Artificial Intelligence/Machine Learning algorithm that receives the number of wireless devices that are authenticated and connected to a wireless network in the space of the building and the number of wireless devices that are probing for the wireless network in the space of the building but are not authenticated and connected to the wireless network.

13. The method of claim 12, wherein one or more of the containers output the estimated occupancy count of the space of the building.

14. The method of claim 13, wherein one or more of the containers execute an Artificial Intelligence/Machine Learning algorithm that receives the WiFi Count and the Probing count and outputs one or more control outputs for controlling the BMS.

15. The method of claim 11, wherein one or more of the containers execute an Artificial Intelligence/Machine Learning algorithm that receives the number of wireless devices that are authenticated and connected to a wireless network in the space of the building, the number of wireless devices that are probing for the wireless network in the space of the building but are not authenticated and connected to the wireless network and one or more additional sensors, and outputs one or more of the estimated occupancy count of the space of the building and/or one or more control outputs for controlling the BMS.

16. An edge controller for a Building Management System (BMS) of a building, the edge controller comprising:
one or more IT inputs for receiving IT inputs from an IT system;
one or more OT inputs for receiving OT inputs from an OT system;
one or more outputs for outputting one or more control outputs for controlling the BMS of the building;
one or more processing resources operatively coupled to the one or more IT inputs, the one or more OT inputs and the one or more outputs, the one or more processing resources executing one or more containers, wherein the one or more containers are configured to:
monitor via one or more of the IT inputs for a number of wireless devices that are authenticated and connected to a wireless network of the building;
monitor via one or more of the IT inputs for a number of wireless devices that are probing for the wireless network of the building but are not authenticated and connected to the wireless network;
determine an estimated occupancy count of the building based at least in part on the number of wireless devices that are authenticated and connected to a wireless network of the building and the number of wireless devices that are probing for the wireless network of the building but are not authenticated and connected to the wireless network; and
provide one or more control outputs via one or more of the outputs based at least in part on the estimated occupancy count.

17. The edge controller of claim 16, wherein the one or more containers are configured to:
determine the estimated occupancy count of the building by:
summing the number of wireless devices that are authenticated and connected to a wireless network of the building and the number of wireless devices that are probing for the wireless network of the building but are not authenticated and connected to the wireless network, resulting a cumulative count;
determining a minimum of the cumulative count during a current day as a baseline;
subtracting the baseline from the cumulative count, resulting in an adjusted cumulative count; and
multiplying the adjusted cumulative count by a constant to determine the estimated occupancy count of the building.

18. The edge controller of claim 16, wherein the one or more containers are configured to:
monitor via one or more of the OT inputs one or more sensed conditions in the building; and
determine the estimated occupancy count of the building based at least in part on the number of wireless devices that are authenticated and connected to a wireless network of the building, the number of wireless devices that are probing for the wireless network of the building but are not authenticated and connected to the wireless network, and the one or more sensed conditions in the building.

19. The edge controller of claim 18, wherein the one or more sensed conditions comprises one or more of motion, a number of card swipes reported by an access control system of the building, CO2 level, power draw level, humidity, and temperature.

20. A non-transitory computer readable medium storing instructions thereon that when executed by one or more processors cause the one or more processors to:
monitor one or more IT inputs;
monitor one or more OT inputs;
determine an estimated occupancy count of at least part of a building based at least in part on one or more of the IT inputs and one or more of the OT inputs;
output a control output to control at least part of a Building Management System (BMS) of a building based at least in part on the estimated occupancy count;
wherein the one or more IT inputs in which the estimated occupancy count is at least partially based includes one or more of:
a number of wireless devices that are authenticated and connected to a wireless network of the building;
a number of wireless devices that are probing for the wireless network of the building but are not authenticated and connected to the wireless network;
a camera count of people in the building reported by a video analytics module of a video surveillance camera of the building; and
a number of card swipes reported by an access control system of the building;
wherein the one or more OT inputs in which the estimated occupancy count is at least partially based includes one or more of motion, CO2 level, power draw level, humidity, and temperature.
